(19) United States
(12) Patent Application Publication
(10) Pub. No.: US 2006/0231048 A1
(43) Pub. Date: Oct. 19, 2006

(54) Revolving engine

(76) Inventor: Jing-Hong Li, Kaohsiung City (TW)

Correspondence Address: John S. Egbert;Harrison & Egbert, 7th Floor, 412 Main Street, Houston, TX, 77002, US

(21) Appl. No.: 11/105,743

(22) Filed: Apr. 15, 2005

(51) Int. Cl. F02B 75/26

(52) U.S. Cl. 123/43 R

(57) ABSTRACT

The revolving engine has a main characteristic of evenly distributing and arranging multiple sets of cylinders horizontally and radially. Moreover, such cylinders are connected together as a unit, thus horizontally revolving as a whole on a fixed central axis. The piston rods all share the same rod journal of the crankshaft allowing the revolving cylinders to share the same plane. When the cylinder body revolves, the pistons slide forward and backward inside the cylinder. The controlling of intake and exhaust is achieved through the differential cam module that revolves around the main journal of the crankshaft. The differential gear ratio of the cam module produces relative differential movement along with the revolving of the cylinder, precisely timing the stroke cycle and the opening and closing of the valves.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an engine, and more particularly to an engine with cylinders being distributed radially and horizontally and presenting jointed and fixed states, which are altogether capable of revolving around a central axis. The engine also possesses an advanced differential gear driven valve train for used in timing of the intake and exhaust valves while the cylinders rotate.

### BACKGROUND OF THE INVENTION

The conventional engine structure and operating principles involve a crankshaft of rotational movement and cylinders fixed with a preset orientation and at a preset position. The piston of each cylinder is connected through the connecting rod to the rod journal on the crankshaft. When the crankshaft drives the motor operation, it also push and pull the piston rod, enabling all pistons to move up or down as a preset sequence. Furthermore, together with ignition and the valve train, the pistons drive the air-fuel mixture of each cylinder to accomplish the engine's four-stroke cycle of gas intake, compression, power and exhaust as the preset sequence. With the repetition of this cycle, the force to drive the crankshaft to rotate continuously is thus acquired.

Although the conventional engine structure has a variety of forms with the ceaseless research efforts of present inventors, the main architecture and operating principle remain unchanged. Therefore, it is really a difficult task to improve the rotational speed of the present engine structure effectively. As for the operating manner of the cylinder pistons of the engine, they move upward and downward, therefore producing much resistance force during the movement, thus limiting the rotational speed (rpm) of the engine. Furthermore, since the closing motion of valves for intake/exhaust is reset only through the force of valve springs; the motion speed is slow and uncertain, easily resulting in gas leakage.

Thus, to overcome the aforementioned problems of the prior art, it would be an improvement to provide an advanced engine structure that can significantly improve its efficiency.

To this end, the inventor has provided the present invention of practicability after deliberate design and evaluation based on years of experience in the production, development and design of various machines.

### BRIEF SUMMARY OF THE INVENTION

The innovative revolving engine can significantly increase not only the rotational speed (rpm), but also the output efficiency due to its revolving movements, further allowing the operation to be smoother and more balanced.

The centripetal force caused by the revolving action of cylinders results in quicker and more efficient closing speed of gas valves, overcoming the shortcomings of easy gas leakage in conventional engines with valve springs, and then largely improving the valve train action quality.

For the present invention, the faster the rotational speed of the revolving engine is, the more significant is the gyroscopic effect, thereby giving the car better handling performance when cornering.

Although the invention has been explained in relation to its preferred embodiment, it is to be understood that many other possible modifications and variations can be made without departing from the original scope of the invention as hereinafter claimed.

### BRIEF DESCRIPTION OF THE SEVERAL VIEWS OF THE DRAWINGS

FIG. 1 shows a front elevation view of the revolving engine.

FIG. 2 shows a schematic lateral view of the revolving engine.

FIG. 3 shows a perspective view of the valve train assembly.

FIG. 4 shows a perspective view of the assembly of the differential cam module with the pushrods of the revolving engine.

FIGS. 5-8 each shows a set of an elevation view and a cross-sectional view of the operation of the revolving engine.

FIGS. 9-11 each shows schematic views of the operation of the single cylinder of the revolving engine.

### DETAILED DESCRIPTION OF THE INVENTION

The features and the advantages of the present invention will be more readily understood with the following detailed description and reference to the accompanying drawings.

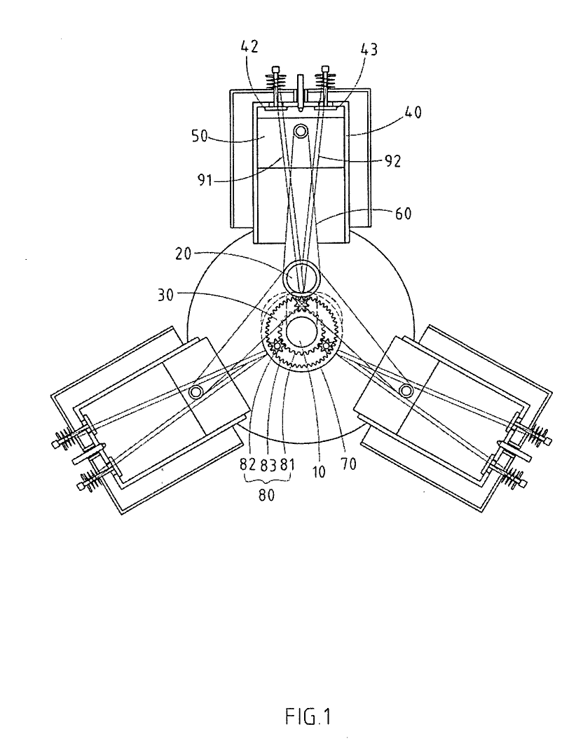

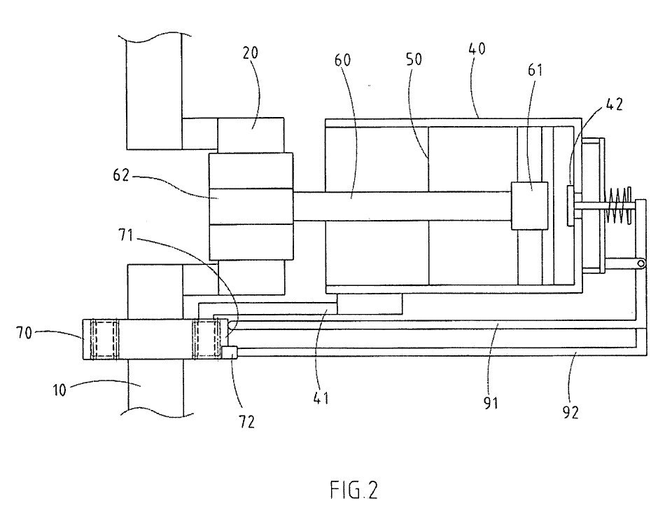

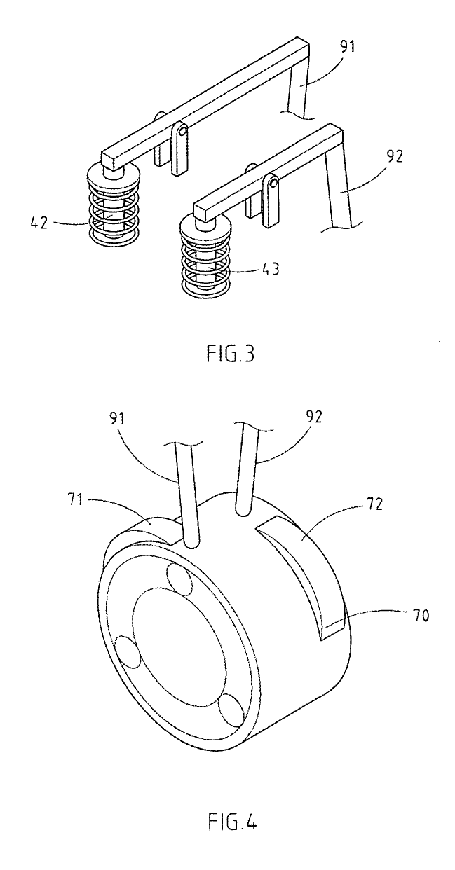

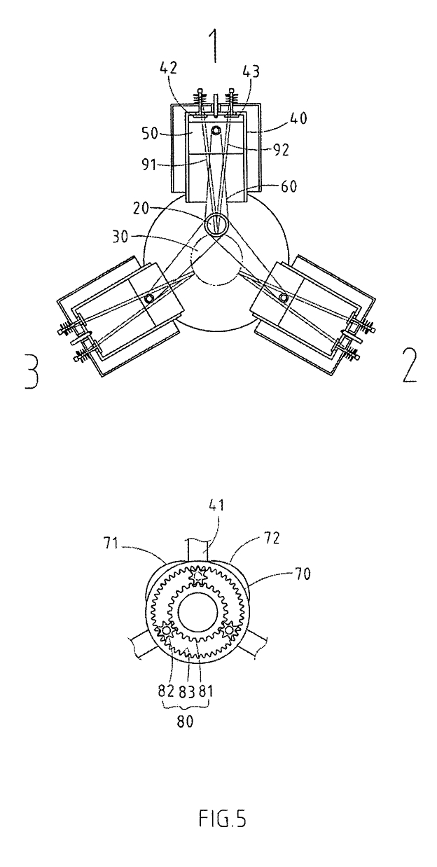

As shown in FIGS. 1-3, this is a revolving engine embodied in the present invention.

The invention includes a fixed crankshaft (10), which forms the central axis of the engine.

There is a single rod journal (20) on the crankshaft, which is shared by three piston rods (with modified connecting rod so the pistons revolve on the same plane) attached to three traditional pistons.

The front of the crankshaft consists of a main journal on which the differential cam module rotates (the ring gear (83) rotates on the planet gears (82) which rotates on the stationary sun gear (81)).

There are three sets of cylinders (40), which are horizontally and radially distributed. The cylinders in this instance forms a fixed framework designed with the mutual angle being 120°. Where as the pistons are attached to and revolve around the rod journal, the cylinders are attached to and pivot around the main journal through the cylinder support bracket (41), which are also attached to the differential cam module (30). The attachment of the cylinder support bracket (41) to the star gear allows timing of the cylinder to the cam lobes and pushrods via the gear ratio within the differential cam module.

A. Explains the Cylinders:
1. How they are attach to one another at 120 degree
2. How they are attach to crankshaft—at rear with retaining bearing, at the planetary gears (at star gears)
3. How cylinder and piston movement are arranged

The intake valve (42) and exhaust valve (43) are set on top of each cylinder.

The pushrods (91), (92) are assembled between the intake/exhaust rocker arms and the cam lobes (71), (72) of the cam gear (70).

The cam gear (70) is part of the differential cam module (30) that controls the intake and exhaust functions. It is the physical outer part of the ring gear (83) that includes the cam lobes. The cam gear revolves around the sun gear (81) by means of the planet gears (82). The sun gear (81) remains stationary on the crankshaft central axis.

Among these, the differential module (30) is comprised of: a sun gear (81) set on the main journal (10); ring gear (83) or cam gear (70) when in reference to the cam lobes attached on its outer surface (70); and planetary gears (82) held by a carrier which rotates between the stationary sun gear (81) and the ring gear (83).

The ratio of the teeth count between the sun gear (81) and the ring gear (82) is 1:2.

Through the above structure and design, the operation of the revolving engine disclosed by the present is explained as follows.

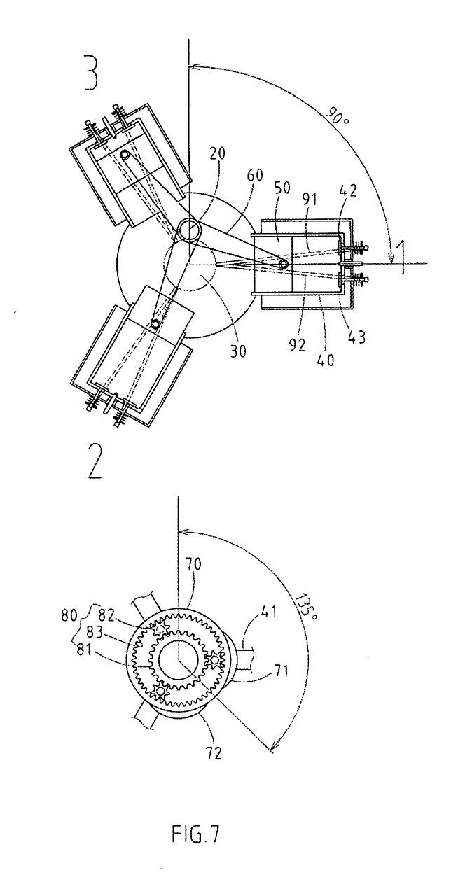

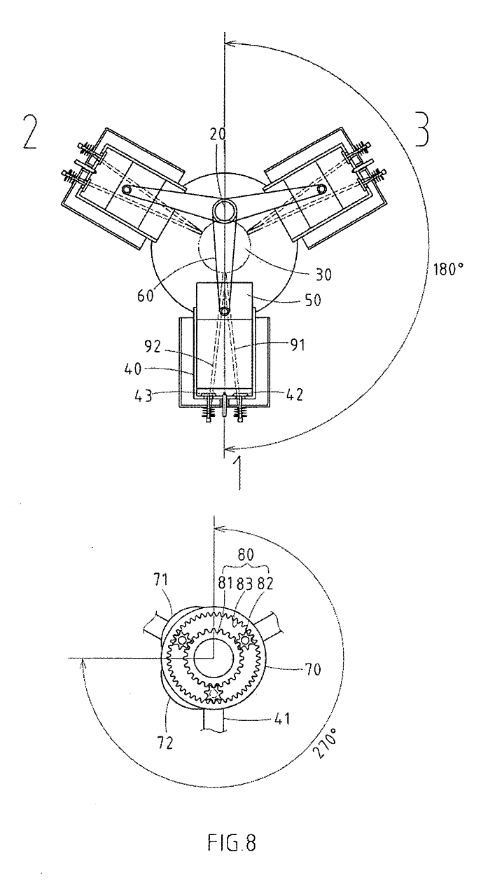

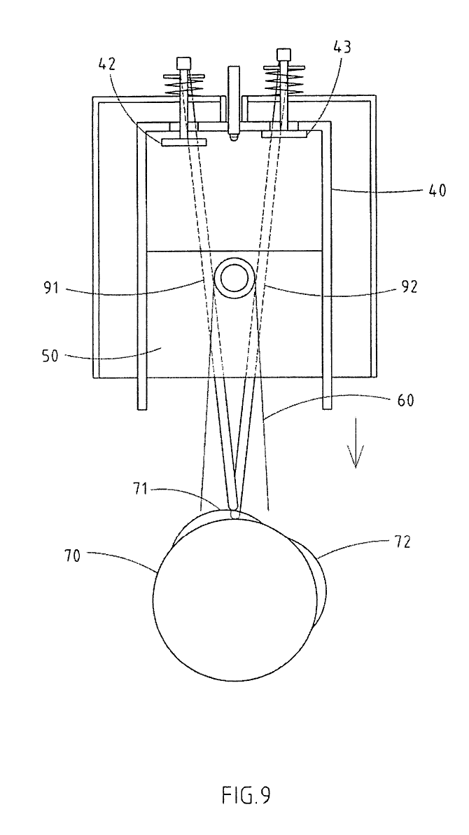

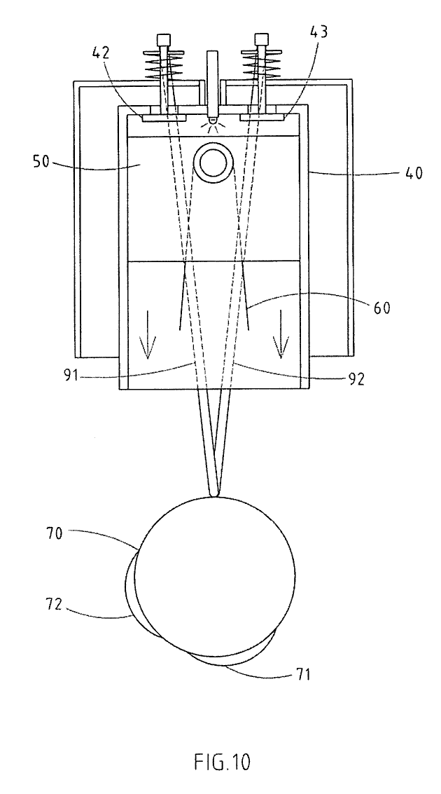

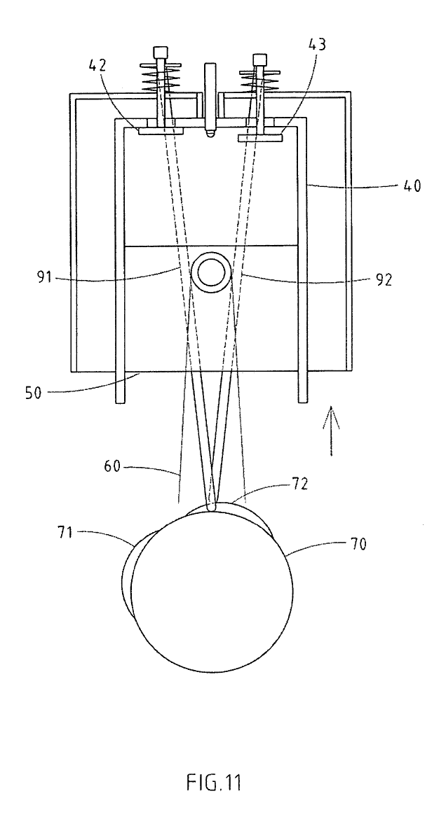

The first point to be explained is that the significant difference between this revolving engine and the traditional one lies in that its crankshaft (10) remains immovable while the cylinders (40) are movable. The cylinders rotate altogether, and the whole operation flow is presented in FIGS. 5-9 in order. As for the single cylinder (40), the relative distance between the cylinders during rotational movement and the rod journal (20) is always changing because the rod journal (20) is off set of the cylinder's central rotating axis or the main journal. According to this principle, as the cylinder rotate, the pistons (50) are caused to slide forward or backward because of the offset rod journal, this action consequently produces the four-strokes (intake, compression, power and exhaust) required to produce continuous motion.

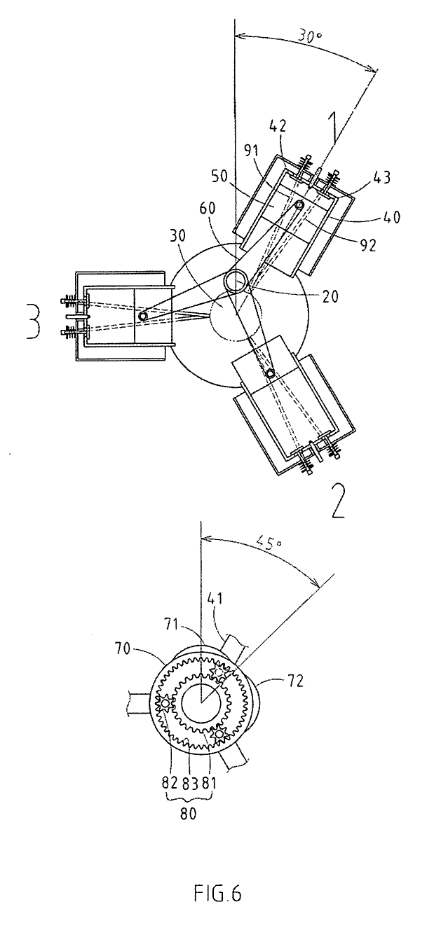

The complete engine stroke cycle takes the cylinders (40) two rotational circles or 720°. For an example, the cylinder on 1 of FIG. 5 is the closest to the rod journal (20), so the piston on 1 cylinder is either on compression or exhaust stroke. On the other hand, as illustrated in FIGS. 6 and 9, the cylinder (40) on 1 is the farthest to the rod journal (20), so it is either on the intake stroke or the power stroke. Because the relative distance between each cylinder and the rod journal (20) is different at any given time, so the stroke of each proceeding cylinder is timed by the differential gear set to be one behind the previous stroke, thus allowing the rotational movement to be continuous. The stroke cycles in the three cylinders are separated by 240°. For example, as the 1 cylinder is on the power stroke, the 2 cylinder is on the intake stroke, however, 240° later, the 2 cylinder would be on the power stroke.

As the cylinders rotate, the cam gear (70) rotates in a relational gear ratio of 2:1 respectively, within the differential module (30), and thus controls the valve train of each cylinder (40). That is, as cam gear turns the cam lobes (71), (72) comes in contact with the pushrods (91), (92), then motioning thru the rocker arms, finally, causing the opening and closing of the intake/exhaust valves (42), (43) on top of the cylinder (40).

I claim:

1. A revolving engine comprising:
a central axis, crankshaft, which is vertically fixed;
a rod journal, which is set in the preset height on the crankshaft;
piston rods, which offset staggers to rotate on the same plane, each rod consisting of two mounting connections for mounting on the main journal;
several sets of cylinders, which are horizontally and radially distributed, the cylinders in this instance forming a framework with the mutual angle being 120° for the triple sets, and being jointed together on the main journal through the cylinder support brackets, so that the cylinders can horizontally revolve as a whole around the central axis as the common pivot;
intake/exhaust valves, which are set on the external side of each cylinder;
a piston, which is installed in each cylinder;
an intake/exhaust control cam, cam gear, pivoting around the circumferential of the sun gear via the planet gears with an intake control cam and an exhaust control cam installed on its outside; and
a differential module, which consists of the intake/exhaust control cam that will produce rotational movement with a preset differential movement as the gears within the module rotate; and pushrods, which are assembled between the intake/exhaust valves and the cam lobes of the cam gear.

2. The revolving engine defined in claim 1, wherein said differential modules comprises:
an external gear, which is set on the central axis; and
an internal gear, which is set on the ring rear cam; and a planetary gear, which is set of bridle joint between external gear and internal gear.

3. The revolving engine defined in claim 2, wherein the ratio of the teeth count between the ring gear and the sun gear is 1:2.

4. A revolving engine, comprising several cylinders, wherein the cylinders are distributed horizontally and radially, and are connected and fixed into an integrated assembly, and capable of revolving as a whole around the main journal; the central axis on the crankshaft.
